(19) United States
(12) Patent Application Publication
(10) Pub. No.: US 2023/0126009 A1
(43) Pub. Date: Apr. 27, 2023

(54) Multilayer Bale Wrap

(71) Applicant: Tama Group, Kibbutz Mishmar Ha'emek (IL)

(72) Inventors: Reuven Hugi, Nahariya (IL); Yori Costa, Kibbutz Mishmar Ha' Emek (IL); Nimrod Lindenbaum, Kibbutz Mishmar Ha' Emek (IL)

(73) Assignee: Tama Group, Kibbutz Mishmar Ha'emek (IL)

(21) Appl. No.: 17/915,725

(22) PCT Filed: Mar. 31, 2021
(86) PCT No.: PCT/IB2021/000203

§ 371 Date: Sep. 29, 2022

Related U.S. Application Data
(60) Provisional application No. 63/002,679, filed on Mar. 31, 2020.

(51) Int. Cl. B32B 27/20; B32B 27/08; B32B 27/30; B32B 27/32; B32B 38/00

(52) U.S. Cl. CPC B32B 27/20; B32B 27/08; B32B 27/306; B32B 27/308; B32B 27/32; B32B 38/004; B32B 2250/03; B32B 2250/246; B32B 2250/40; B32B 2307/31; B32B 2307/402; B32B 2310/0806

(57) ABSTRACT

A bale wrapping system includes an emitter configured to generate electromagnetic radiation within an emitted spectrum and a wrap. The wrap includes a melt layer containing an additive absorbent to at least some electromagnetic radiation within the emitted spectrum and a solid layer substantially free of the additive.

### CROSS-REFERENCE TO RELATED APPLICATIONS

The present application claims the benefit of U.S. Provisional Application No. 63/002,679, filed on Mar. 31, 2020, the disclosure of which is hereby incorporated herein by reference.

### BACKGROUND OF THE INVENTION

Baling agricultural products is a well-known and frequently used practice throughout the world. Various methods, techniques, products, materials and equipment have been used to harvest, bale and wrap agricultural products. In recent years, knitted nets and films have been replacing the wire/sisal twine and baling twine which have been traditionally used. These nets and films are commonly constructed of polypropylene/polyethylene.

Some recent wrapping materials have included a tacky film for wrapping baled items, such as agricultural products. Such products have also been applied in a supplemental use after wrapping the bale with net or twine, with the aim of producing silage. Alternatively, such films could also be used as a replacement to the net or the twine, or any other alternative wrapping material. In any event, typically, these various types of wrapping methods and products require more than one layer of wrapping material.

Regardless of the wrapping material used, the wrapping material must maintain the bale within the wrapping until the user opens the bale for use in its designated purpose, such as: distribution of the agricultural product in the targeted area (manger or stall); feeding and/or processing; or the like. Although the film is tacky, due to dusty conditions, moisture or wind, the tackiness is often not sufficient to keep the tail fastened, such that the tail opens prematurely compromising the wrap and, potentially, the baled item within the wrap by, for example, exposing the baled item to the environmental elements.

Since the wrapping material is wound on a storage roll, prior to use, the maximum level of tackiness which can be bestowed on the film is limited to a tackiness level which allows release of the wrapping material from the roll of material for use in the wrapping process.

An additional disadvantage and limitation which exists in prior art tacky films is that the tackiness of the film is uniform throughout the area of application, and may be positioned on both sides, or on one side only.

Consequently, due to the low bonding strength of such materials with such a given level of tackiness, which is imparted during the manufacturing process of the wrapping material, many such materials are manufactured to include tacky areas along the entire length of one side or both sides of the film. In each of these cases, the entire area of the film is tacky and the level of tackiness is limited to the strength required in order to release the wrapping material from the roll of material. There are two fundamental disadvantages with such tacky wrapping materials: first, the level of tackiness must be limited, and second, the tackiness is essentially uniform over the entire wrapping area. In other words, such tacky films must balance between ease of use in removing the wrapping material from the roll and providing sufficient tackiness to ensure the baled item retains its integrity prior to use.

Still further, such tacky films can have the additional drawback in that the tacky film could adhere to the agricultural product itself, causing loss of crop adhered to the film, and creating difficulty in recycling the dirtied film after unwrapping. These issues are particularly troublesome when the baled agricultural product is cotton or hay.

### BRIEF SUMMARY OF THE INVENTION

The present disclosure relates to a bale wrap that may include a solid layer and a melt layer. The melt layer may have one or more properties enabling it to be melted in isolation from the solid layer. The properties enabling the melt layer to be melted in isolation from the solid layer may include an additive within the melt layer that may be absent or substantially absent from the solid layer. The additive may be absorbent of electromagnetic (EM) radiation within a spectrum to which the solid layer is transparent.

According to one aspect, the bale wrap may be applied and sealed to a baled item (also referred to herein as the baled agricultural product) by wrapping the bale wrap around the baled item in multiple layers and directing EM radiation within the spectrum absorbed by the additive within the melt layer of the bale wrap. The EM radiation may freely pass through the solid layer of an outermost layer of the bale wrap until it reaches the underlying melt layer. Because the solid layer may be free or substantially free of the additive, the EM radiation passes through the solid layer with minimal effect on the solid layer and travels to the melt layer. The additive within the melt layer may absorb the radiation and convert the radiation to heat, thereby melting the melt layer to join two adjacent solid layers, and therefore two adjacent layers of the bale wrap, thus sealing the bale wrap where it has been irradiated. Further, since the melt layer absorbs most if not all of the radiation, the baled item within the wrapping material is not affected by the radiation.

According to another aspect, a bale wrapping system may include an emitter configured to generate EM radiation within an emitted spectrum and a wrapping material. The wrapping material may include at least one melt layer containing an additive absorbent to at least some EM radiation within the emitted spectrum and at least one solid layer substantially free of the additive.

In some arrangements, the system may be configured to wrap a baled item where the wrapping material includes a structure whereby the at least one melt layer faces the item being baled and the at least one solid layer is positioned outside of the at least one melt layer.

In some arrangements, the additive may be carbon black, or other radiation absorbing pigments.

In some arrangements, the solid layer may include a pigment reflective of at least some of a visible spectrum. In such an arrangement, the energy emitter may generate EM radiation within another part of the spectrum. For example, the emitter may emit energy at a wavelength of 1300 nanometers (nm), which is in the infrared (IR) range, and the selected pigment is green. In another example, the wavelength may be equal to or about 976 nm, which is also in the IR range. The foregoing wavelengths are merely examples, and any wavelength within the IR range may be usable with a properly pigmented melt layer. The melt layer in such an example may include carbon black to absorb the IR emission.

In some arrangements, the melt layer may include an additive absorbent of at least some of a visible spectrum. In such an arrangement, the energy emitter may generate EM radiation within the visible spectrum. For example, the emitter may emit energy at a wavelength of 450 nm, which is in the violet or blue range, and the additive is yellow.

In another example, the emitter generates EM radiation within the infrared range, or in another example, within the ultraviolet range. The additive used with either of these alternative examples may be carbon black, which is capable of absorbing all wavelengths, or may be a different additive suitable for the specific emitted wavelength.

In some arrangements, the solid layer may include a plurality of sublayers.

In some arrangements, at least one of the sublayers may include a pigment reflective of at least some of a visible spectrum. For example, at least one of the sublayers may have a yellow or green pigment while other sublayers of the solid layer may also include the pigment, may include a different pigment(s), or may not include the pigment (e.g., remain clear). In one further example, a sublayer furthest from the melt layer may be a transparent sublayer. In yet a further example, the sublayers other than the transparent sublayer may be collectively opaque to the visible spectrum.

In some arrangements, the solid layer may be transparent to the emitted spectrum, and the melt layer is opaque to the emitted spectrum.

In some arrangements, the emitter may be drivable to direct radiation at different points across a width of the wrap.

In some arrangements, the emitter may be drivable in a pattern relative to the baled item, such as in an oscillating pattern.

In some arrangements, the emitter may include multiple emitters, each of which may be stationary or drivable relative to the baled item, such that the plurality of emitters can establish a pattern of melting of the melt layer.

In any of the above arrangements, the amount of melt layer which receives the energy from the emitter may vary, both along the width of the wrapping material or along the circumference of the wrapping material around the baled item. Any percentage of the melt layer may receive the energy from the emitter, from more than 0% up to complete melting of 100%. In some examples, the portion of the melt layer receiving the energy from the emitter may include only the melt layer or layers on the tail end or in contact with the tail end of the wrapping material around the baled item. In other examples, the portion of the melt layer receiving the energy from the emitter may extend around at least a portion of, substantially the entirety of, or the entirety of the circumference of the wrapping material around the baled item.

In yet another aspect, a method of sealing a wrapped baled item may include wrapping the bale by rolling the bale while applying a wrap to the bale. The wrap may include a melt layer containing an additive and a solid layer substantially free of the additive. The method may further include melting at least part of the melt layer by directing EM radiation at the wrap. The EM radiation may be within a range of wavelengths absorbable by the additive.

In some arrangements, the melting step may be performed during the wrapping step.

In some arrangements, the melting step may begin after the wrap is applied to an entire circumference of the bale such that the EM radiation does not reach the bale.

In some arrangements, the melting step may include driving an emitter to direct the EM radiation at differing points across a width and/or length of the wrap.

In some arrangements, the melting step may be performed after the wrapping step is complete.

In some arrangements, the melting step may be performed by emitting the EM radiation from an emitter, and wherein the emitter and the bale are immobile relative to one another throughout the melting step.

### BRIEF DESCRIPTION OF THE DRAWINGS

FIG. 1 is a cross-sectional view of a portion of a wrap according to one aspect of the disclosure.

FIG. 2 is a schematic illustration of one example of a system for applying the wrap of FIG. 1.

FIG. 3 is a schematic illustration of the system of FIG. 2 during operation.

FIGS. 4A and 4B are cross-sections of the wrap of FIG. 1 being sealed according to various arrangements of the disclosure.

FIGS. 5A-5G are illustrations of baled items wrapped by the system of the present disclosure, such as those illustrated in FIGS. 2 and 3, sealed according to various arrangements of the disclosure.

FIG. 6 is a flowchart illustrating a method of using the system of the present disclosure, such as is illustrated in FIGS. 2 and 3.

FIGS. 7A-7E are illustrations of baled items wrapped by the system of the present disclosure according to alternative arrangements.

FIG. 8 is a cross-sectional view of a portion of a wrap according to another aspect of the disclosure.

FIG. 9 is a cross-sectional view of a portion of a wrap according to another aspect of the disclosure.

FIG. 10 is a graph of electromagnetic absorbance of an example wrap composition at various wavelengths.

FIG. 11 is a graph of electromagnetic absorbance of an example crop at various wavelengths.

### DETAILED DESCRIPTION

When referring to specific orientations, dimensions, or compositions of elements in the following disclosure, it should be understood that both the precise quantity or example given and functionally equivalent values are contemplated. For example, if a compound is stated to be 90% of a given element or composition, near equal compositions being, for example, 88% to 92% of that same compound are contemplated. The range of such approximations should be considered to encompass all nearby values that a skilled person would understand to perform in a substantially equivalent manner to the specific value stated.

The bale wrap (sometimes referred to as wrapping material) of the present disclosure is used for wrapping a baled item, for example agricultural products such as cotton or hay, though other crops and materials are also envisioned. Non-agricultural applications are also contemplated. For example, the systems and methods described herein could be used with any object or substance that may need to be wrapped, such as shipping wraps, pallet wraps, and the like. This bale wrap provides a cost-effective solution as opposed to various products currently available since, for instance, this bale wrap does not include a tacky film layer, which can be expensive to produce. The wrap may be provided with a powder to prevent self-adhesion. Instead, this bale wrap utilizes a simple construction particularly designed for use with an energy source or emitter, such as the example of an EM emitter as mentioned herein, which energizes at least one layer of the bale wrap to cause it to melt, and upon re-solidification, results in a strong bond within the bale wrap, and as a result, a strongly wrapped baled item.

Moreover, as will be evidenced herein, the bale wraps and techniques of the present disclosure provide a safety benefit over various products currently available because, upon forming the bond through the use of the emitter to melt a portion of the bale wrap, the bale wrap becomes a unitary piece of material around the baled item. This could be important because, upon cutting open of the bale wrap to release the baled item, the bale wrap would be removed from the baled item in a single piece. This benefit upon removal of the bale wrap after use may minimize, if not eliminate, any portions of the bale wrap from comingling with the baled item, which could cause contamination of the baled item.

Additional safety measures are also envisioned. For instance, the system may further include an RFID identification feature. For example, each bale or baled object may include an RFID tag, and the baler or emitter may be inoperable without an RFID tag properly located with respect to the baler, such as within a bale rolling unit. As such, the RFID feature may reduce or eliminate instances where the emitter turns at a time other than during a baling operation, thereby reducing or eliminating instances where a user could come into contact with the emitted energy, which could injure the user.

As discussed herein, the energy source may be any source capable of providing energy to the bale wrap. The primary example used herein is an EM emitter (such as a light source, a laser, an LED array, or the like), though other sources are also available, such as a solid heating element, a hot air supply, ultrasonic source, or the like. As used herein, an EM emitter providing energy at a desired wavelength will be the primary example, though again, other energy sources may be used. Regardless of the energy source used, it is important to position the energy source within the baling machine (used to collect, organize, and ultimately wrap the baled item with the bale wrap) such that the chance of injury to the user, the bale wrap, and the baled item is minimized.

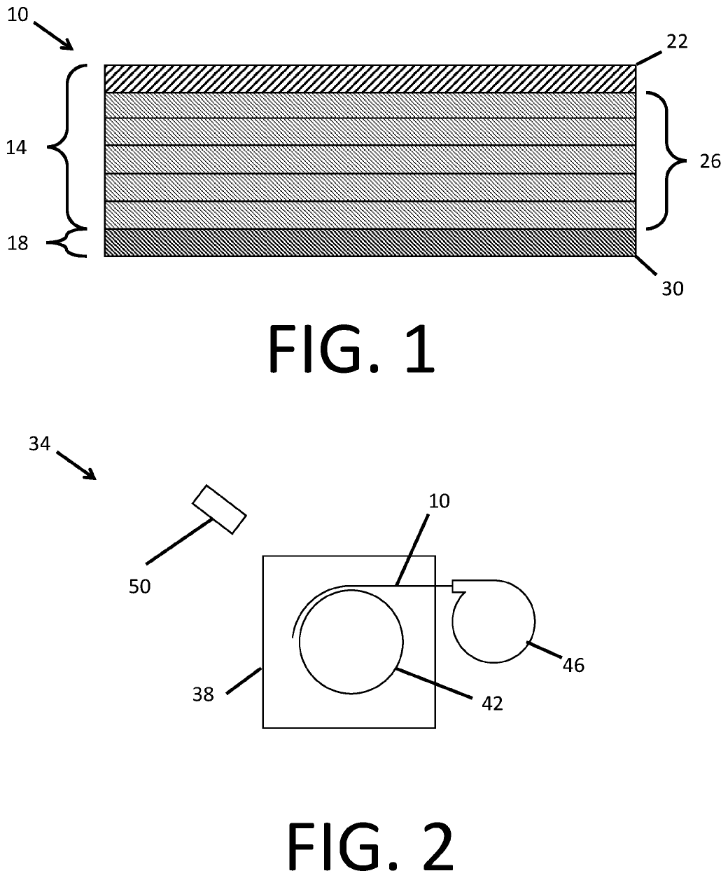

FIG. 1 illustrates one aspect of the present disclosure as a bale wrap 10 including a solid layer 14 and a melt layer 18. Both the solid layer 14 and the melt layer 18 include a polymer or polymer blend with various additives, and may be further divided into sublayers. In the illustrated arrangement, the solid layer 14 includes six sublayers, and these six sublayers include one outermost sublayer 22 and five middle sublayers 26, though in alternative arrangements the solid layer 14 is one continuous layer, such as, for example, a single continuous layer of medium density polyethylene (MDPE), or any number of sublayers. In various other arrangements, the solid layer is anywhere from about 10 to about 300 microns thick, with some more specific examples being 62 microns and 92 microns, or equal to or about 60 microns, 70 microns, 90 microns, 100 microns, between 60 and 70 microns, or between 90 and 100 microns. All sublayers of the solid layer 14 may be made from the same or similar types of polymer. In some arrangements, all six sublayers of the solid layer 14 are polyethylene. In some particular examples, the outermost sublayer 22 is 100% MDPE or almost 100% MDPE, with the balance being additives such as stabilizers and antiblock additives, and the middle sublayers 26 are 10% low density polyethylene (LDPE) and 90% linear low density polyethylene (LLDPE), or nearly 90% LLDPE with the balance being additives. While the layers may be formed of any material or combination of materials desired, it is preferred that the solid layer may not have a tacky surface. The use of a melt layer 18, provided by a material 30 differing in overall composition from the solid layer 14, eliminates the need for the solid layer 14 to have a tacky surface, though the solid layer may still have a tacky surface even if the melt layer 18 is included in the bale wrap 10.

The solid layer 14 may optionally include a pigment in at least one layer (or in the single layer if formed of only a single layer). The pigment can be reflective to at least some visible light. For example, the pigment may be yellow, green, or white, but any color may be suitable depending on a desired application, look, use, or the like. For instance, where the bale wrap may be used on a baled item which will remain outside, exposed to the sun, or used with a baled item that is sensitive to temperature and/or sun exposure, a light color or reflective pigment may be selected to limit effects of external radiation on the baled item. Such a pigment may reduce conversion of radiation to heat. For example, light colored pigments, particularly white, yellow, green, or light blue pigments, may be used in the solid layer 14 of wrap 10 when intended for applications where wrapped bales are likely to stay outdoors. Because the light colors would reflect most visible light, the pigments would limit the amount that light from the sun would heat the bales. Ultraviolet radiation may be particularly destructive to certain crops, so in some arrangements, the pigment may also be reflective or absorbent of nonvisible wavelengths such as ultraviolet radiation, infrared radiation, or both.

In the illustrated arrangement, the outermost sublayer 22 is free of the pigment and thus transparent to the visible spectrum, and the middle sublayers 26 collectively contain enough pigment to be opaque to the visible spectrum. In further arrangements, the pigment may be limited to any one or any subset of the middle sublayers 26, or if the solid layer 14 is a single layer, the single layer may include the pigment. In alternative arrangements, the solid layer 14 is transparent and free of pigment.

Continuing with the illustrated arrangement of FIG. 1, the melt layer 18 is illustrated as a single layer of about 8 microns in thickness, but in other arrangements the melt layer 18 may be manufactured in multiple sublayers and/or other thicknesses if suitable for a given purpose. In various other arrangements, the melt layer 18 is anywhere from equal to or about 2 to equal to or about 100 microns thick. Further, the melt layer 18 may be made from the same or similar types of polymer or polymer blends as the solid layer 14. In other arrangements, the melt layer 18 is made from a different material, such as for example an ethylene vinyl acetate copolymer resin (EVA), ethylene butyl acrylate (EBA), PE or polyamide (PA, or Nylon), or combinations thereof. The exact composition may vary depending on the composition of the solid layer and the application. In a particular example, the melt layer 18 includes 80-99.5% EVA, with 19% vinyl acetate by weight (EVA19), with the balance being carbon black. In another arrangement, EVA provides more than 90% of the melt layer 18, with the balance being carbon black. In various further arrangements, carbon black is 20%, 15%, 5%, 2.5%, or 0.02% or within a range of greater than 0.0% up to and including 20%, greater than 0.0% up to and including 15%, greater than 0.0% up to and including 5%, greater than 0.0% up to and including 2.5%, and greater than 0.0% up to and including 0.02% of the melt layer 18, with the balance being EVA. In yet further arrangements, the melt layer 18 has the same composition as the solid layer 14, except for the presence of an EM absorbent additive in the melt layer 18. Prior to the application of energy, the melt layer 18 may not have a tacky surface. Thus, in this arrangement and indeed as a benefit to such arrangements of the present disclosure, both outer surfaces of the wrap 10 are not tacky.

Other exemplary materials that may be included in the solid layer 14, melt layer 18, or both include polyamide (PA, Nylon), polyolefin, polypropylene, polyethylene, or any other polymer that may be formed into a film. In some embodiments, the polymer composition of the melt layer 18 has a lower melting point than a melting point of the polymer composition of the solid layer 14.

The particular material forming the melt layer 18 may have a melting temperature similar to or lower than that of at least one layer of the solid layer 14 such that, upon the application of energy to the wrap 10, the melt layer 18 melts while the solid layers melt to a lesser degree or not at all. For example, the melt layer 18 may have a melting temperature that is less than that of any layer within the solid layer 14. In some alternatives, the melt layer 18 may have a melting temperature that is equal to, approximately equal to, or slightly greater than the melting temperature of the layers within the solid layer 14. However, as explained further below, the melt layer 18 may include an additive capable of absorbing the energy while such energy can pass through the solid layer 14, and thus the relative melting points of the materials in the melt layer versus the solid layer can vary.

Continuing with this exemplary arrangement, the melt layer 18 contains an absorbent additive that is absent, or at least substantially absent, from the solid layer 14. The additive is a compound that is absorbent to the particular energy applied from the energy source, such as electromagnetic (EM) radiation within a selected spectrum from an EM emitter, which upon absorption by the melt layer is converted to heat. The selected spectrum that is absorbable by the additive must extend outside any spectrum to which the solid layer 14 is opaque. The melt layer 18 contains enough of the additive that it is possible to melt the melt layer 18 by directing radiation within the selected spectrum through the solid layer 14 to the melt layer 18, and in some arrangements, the melt layer 18 contains enough of the additive to be opaque to the selected spectrum. In some further arrangements, it is possible to melt the melt layer 18 by directing radiation in the selected spectrum through the solid layer 14 without melting the solid layer 14, or without melting more than one sublayer of the solid layer 14 that is directly adjacent to the melt layer 18.

An additive may be selected as appropriate for a given application. Various factors that may be considered in selecting the additive include spectra transmissible through the solid layer 14, spectra harmful to the crop, storage conditions for wrapped bales, and what type of EM emitter is available for sealing the wrap 10. Carbon black, for example, may be a suitable additive for many applications because it is absorbent of a broad spectrum of EM radiation. Particularly, use of carbon black as an additive in the melt layer 18 will protect the bale from most external radiation, and is compatible with many types of pigments for use in the solid layer 14 and many types of energy emitters that may be used for melting the melt layer 18.

In addition to the examples above, the wrap 10 may be composed of various combinations of materials as appropriate for the energy source used to melt the wrap 10, or alternatively, the energy source is selected to be appropriate as to a desired combination of materials forming the wrap 10. Still further, the wrap material and energy source may be dependent upon the desired product or item to be wrapped. Certain, non-limiting, examples are presented in the table below, but it should be understood that the materials and energy sources may be varied or interchanged as appropriate or convenient for any given application.

| Solid layer | Melt layer | Additive | Energy source |
|---|---|---|---|
| Polypropylene | LLDPE | Carbon black | IR Laser (1310 nm) |
| HDPE | LLDPE | Yellow pigment | Blue Laser (451 nm) |
| LLDPE | EVA 19% | Carbon black | IR Laser (950 nm) |
| HDPE | MDPE | Red pigment | Green laser (532 nm) |
| PA66 | PA6 | Yellow pigment | Blue Laser (451 nm) |
| LLDPE | PP | Carbon black | Laser Diode (1310 nm) |
| | elastomer | | |
| HDPE/MDPE | EVA 19% | — | Hot air blower |

The resulting melt layer 18 may provide for improved strength to other various wraps known in the art. For example, when using the aforementioned EVA, the peel strength between adjacent, joined layers has been measured as being at least 0.5 Newtons/25 mm, while the shear strength between adjacent, joined layers has been measured as being at least 10.0 Newtons/25 mm² of melted area. In various other examples, the peel strength may be anywhere from about 0.5N Newtons/25 mm up to the ultimate peel strength of the wrap 10 itself.

As shown in FIG. 2, one embodiment of a system 34 for wrapping a baled item 42 with the bale wrap 10 includes a rolling or baling machine 38 (as known in the art), a wrap dispenser 46 (as known in the art), and an energy source, such as an EM emitter 50, capable of emitting radiation within the selected spectrum absorbable by the additive in the melt layer 18. In testing, wrapping speeds of greater than or equal to 20 meters of wrap per minute have been achieved using certain configurations of the apparatus and methods disclosed herein. Both the solid layer 14 and the melt layer 18 may be solid at room temperature, but they are so named because, in some examples of the illustrated joining process, the melt layer 18 may melt while at least a portion of the solid layer 14 remains solid. In various arrangements, the emitter 50 can emit a specific wavelength, a narrow band of EM radiation, or any combination of infrared, ultraviolet, and visible EM radiation. The emitter 50 may be selected to emit radiation within a spectrum that the baled item 42 is unlikely to absorb. For example, certain varieties of cotton (particularly, the seeds and leaves typically contained in harvested and to-be-baled cotton) absorb relatively little EM radiation within a spectrum of between about 1200 nm and about 1400 nm in wavelength, with wavelengths within a spectrum of about 1320 nm being the least absorbed. An emitter 50 in some arrangements for use with those varieties of cotton may therefore be selected or configured to emit radiation mostly or only within the spectrum of between about 1200 and 1400 nm, or within a spectrum or wavelength of about 1320 nm. The rolling machine 38 may be any known device with features for holding and rotating the crop to form and organize the crop into a baled item 42 while drawing and pressing the bale wrap 10 around the baled item 42.

The pigment for use within the solid layer 14, the additive used in the melt layer 18, and the emitter 50 are generally chosen to have cooperative properties. In a specific example, the additive should be absorbent to at least some wavelengths that can pass through the pigment, and the pigment should be opaque to spectra that should not act on the additive. Further, the emitter 50 should be able to emit at least some wavelengths that can pass through the pigment and be absorbed by the additive. Further still, the emitter 50 should be configured to have an intensity sufficient to melt the melt layer 18 by directing radiation through the solid layer 14, but may be limited to reduce or avoid effects on the baled item 42. The pigment and the additive may be chosen such that, together, the solid layer 14 and melt layer 18 will be opaque to some spectra that would produce undesirable effects on the bale. In an exemplary arrangement for use in outdoor applications, the additive is carbon black, and the pigment is opaque to the visible spectrum, but transparent to infrared radiation. In a more specific example according to the foregoing, the pigment is also opaque to ultraviolet light. In either arrangement, the pigment reduces the amount of radiation from the sun that reaches the melt layer 18, thus protecting the bale from unintended heating. However, the emitter 50 may be an infrared emitter, and the melt layer 18 may be melted by directing infrared radiation through the solid layer 14 to the melt layer 18.

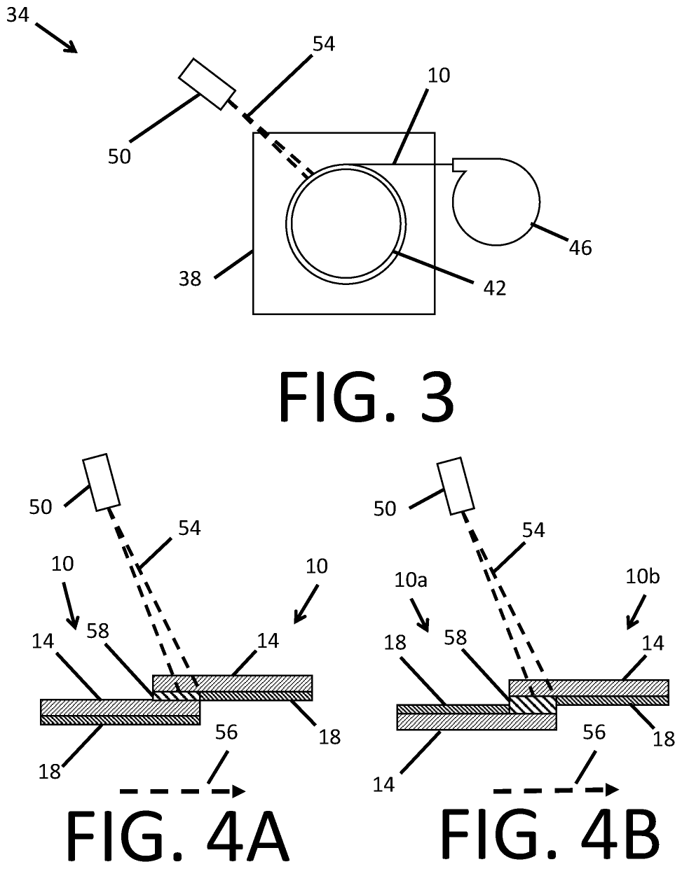

Turning to FIG. 3, the emitter 50 is activated after the baled item 42 has been wrapped around its entire circumference such that at least two layers of the bale wrap 10 overlap and cover a circumferential point on the bale at which the emitter 50 is directed. The system 34 may check that the wrap 10 is being applied to the baled item 42, such as by checking for RFID associated with the wrap 10, the baled item 42, or both, and that the baled item 42 has been turned at least through one full revolution before activating the emitter 50. The emitter 50 may be activated for a specific duration of time, which may be predetermined or a function of parameters such as rotation speed and diameter of the baled item 42, before shutting off and potentially being reactivated. Radiation 54 within the selected spectrum is generated by the emitter 50 and directed at a particular surface area of the wrap around the bale 42 to melt the melt layer 18 at that surface area such that, upon cooling and re-solidification of a melted portion of the melt layer 18, at least two overlapping layers of the wrap 10 will be joined to one another.

In the exemplary arrangement shown in FIG. 4A, two overlapping layers of wrap 10 may be moved in a rolling direction 56 relative to the emitter 50 prior to activation of the emitter 50. The wrap 10 in the example shown in FIG. 4A is oriented relative to the baled item 42 (not shown in FIG. 4A or 4B, item 42 is labeled only in FIG. 3) such that the melt layer 18 of each layer of wrap faces toward the bale 42 (e.g., as illustrated in this arrangement, melt layer is a bottom-most layer of wrap 10). The radiation 54 from the emitter 50 travels through the solid layer 14 of the layer of wrap 10 that is closer to the emitter 50 and melts the corresponding melt layer 18 into a joint 58. Though the melt layer 18 of the inner (to the left as shown in FIG. 4A) layer of the wrap 10 contacts the bale 42, no melted substance contaminates the bale 42 because the melt layer 18 of the outer layer of the wrap 10 absorbs the radiation 54. The joint 58 is initially liquid, but upon solidifying the joint 58 adheres to both adjacent solid layers 14. Stated another way, the solidified joint 58 adheres to the solid layer 14 onto which the melt layer 18 was formed as well as to the solid layer 14 of the opposing layer of wrap 10. As noted above, joint 58 results in forming a single wrapping material which, upon subsequent cutting of the wrap (at some location around its circumference) results in a single piece of wrapping material which can be removed from the baled item and which may result in decreased contamination of the baled item by remnants of wrapping material.

Other configurations of the melt layer 18 relative to the wrap structure overall are also envisioned. For instance, while the melt layer 18 in FIG. 4A faces towards item 42 (not shown), the melt layer 18 could instead be on the top of the wrap 10 such that it faces away from the item 42. Still further, the melt layer 18 could be positioned as the top layer along part(s) of the wrap 10, and be positioned as the bottom layer along other part(s) of wrap 10. Still further, the melt layer 18 could be present on only a portion or portions of the wrap 10, such as intermittently spaced along the length of the wrap 10 (and again, positioned as desired as the top layer and/or bottom layer of the wrap 10).

For example, in an exemplary alternative arrangement shown in FIG. 4B, bale wrap 10 may include a nonuniform structure along its length, such that one portion of wrap 10a includes melt layer 18 as a “top” layer of the wrap, while a second portion of wrap 10b includes melt layer 18 as a “bottom” layer of the wrap. In this arrangement, melt layer 18 of portion 10a may face away from baled item 42 (not shown), while the melt layer of portion 10b still faces towards the baled item 42. Such an arrangement, while perhaps being more difficult to manufacture, may provide two benefits. First, at least part of the baled item 42 will not have a melt layer 18 directly contacting it, contrary to FIG. 4A, such that any potential risk of inadvertent melting of that portion of melt layer 18 is minimized Second, the two melt layers 18 face one another such that they come into contact one another once on the item 42, such that directing radiation 54 through the solid layer 14 of the second portion of wrap 10b melts both melt layers 18 to form a joint 58 of twice the thickness of the joint 58 shown in FIG. 4A and may reduce the energy needed for welding and/or the minimum thickness of the melt layer.

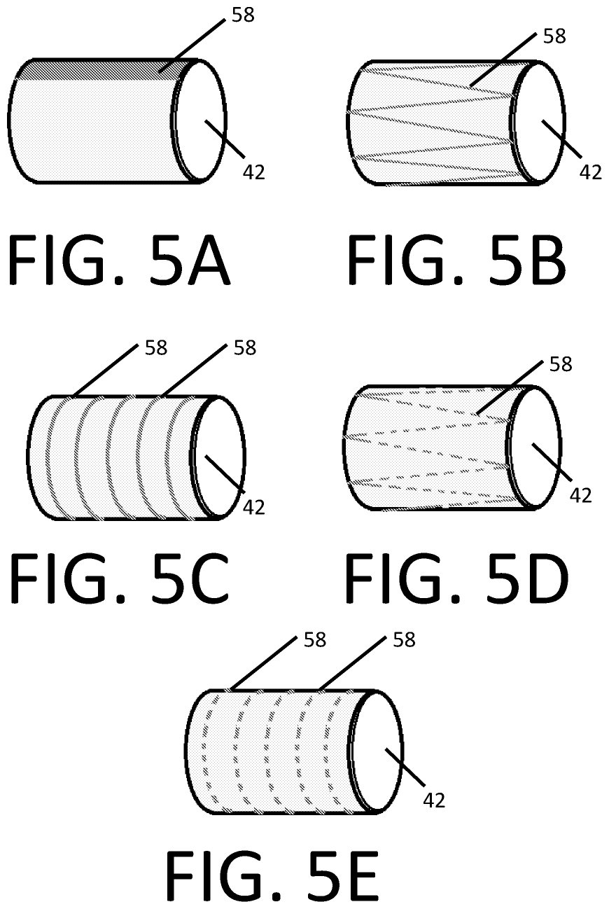

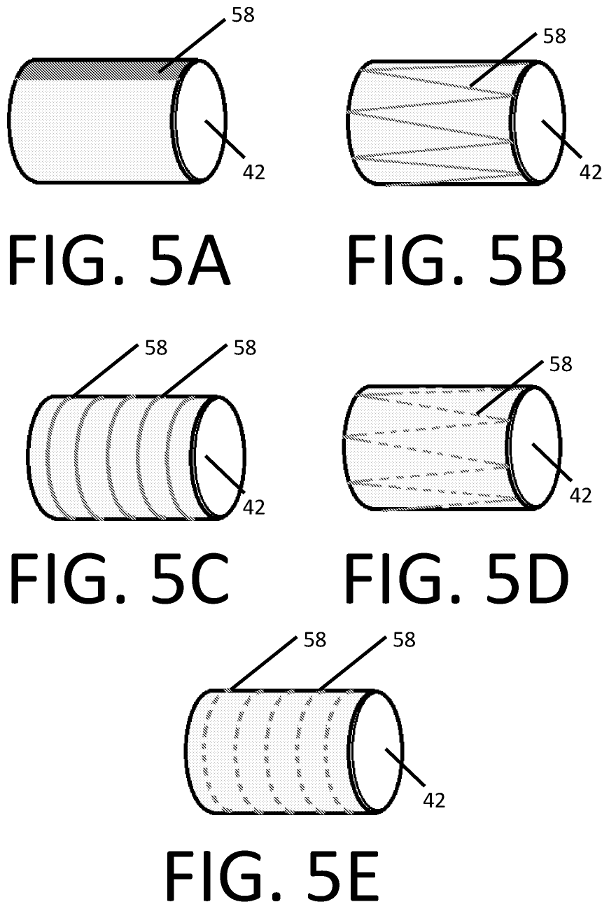

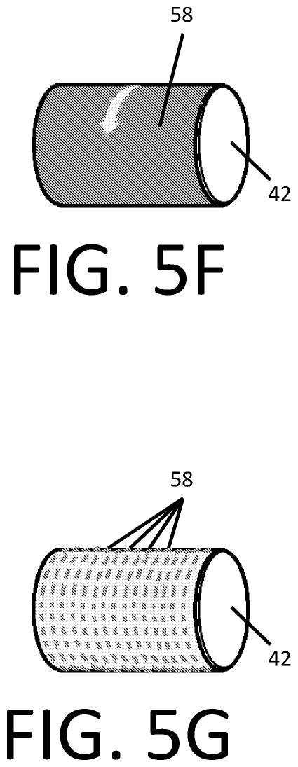

The joint 58 may be formed in any of a variety of shapes and patterns as shown non-exhaustively in various examples of FIGS. 5A-5E. The patterns may be achieved with one emitter 50 or an array of emitters 50. The emitter or emitters 50 may be moveably mounted, such as to an element drivable by a motor. In some arrangements, the motor is a servo motor governed by a controller associated with the system 34. The emitter or emitters 50 may also be governed by a controller associated with the system 34.

A broad band-shaped joint 58 as shown in FIG. 5A may be produced by moving a single emitter 50 laterally along a stationary bale 42. Alternatively, the joint 58 of FIG. 5A may be produced by pulsing a broad emitter 50 or array of emitters 50 once while the bale 42 and emitter or emitters 50 are relatively stationary relative to one another. Such a type of welding can be considered “specific area” welding in that energy has been applied to only a particular portion of the circumference. This type of welding may be performed while the baled item 42 is stationary or while it is moving, though the emitter 50 should be stable relative to the specific surface area in order to achieve welding at this specific area. This exemplary arrangement may be used to secure the tail end of the wrap 10 to the layer of wrap positioned underneath the tail end, though such lateral band-shaped joint(s) 58 could be positioned anywhere on the circumference of the bale 42.

Alternatively, the baled item 42 may be rotated while the emitter or emitters 50 remain active to seal the wrap 10 around a larger amount of the circumference of the wrap, or entirely around the circumference. These configurations may be created during one or more rotations of the baled item 42 relative to the emitter or emitters. For example, a saw tooth pattern of the joint 58 as shown in FIG. 5B may be produced by moving or rotating an emitter 50 back and forth relative to the bale 42 as the bale 42 is rotated within the rolling machine 38. A similar, but more rounded pattern of the joint 58 may be produced by moving the emitter 50 in an oscillating manner relative to the bale 42 while the bale 42 is rotated within the rolling machine 38.

In another arrangement, multiple emitters 50 spaced along the bale 42 may be activated constantly while the bale 42 is rotated within the rolling machine 38 to produce the joints 58 in parallel rings as shown in FIG. 5C. Alternatively, a single emitter 50 may be used to make each parallel ring joint 58, and may be shut off, moved laterally, and reactivated between completing a ring and beginning a next ring.

In still another arrangement, the dashed patterns of FIGS. 5D and 5E may be produced according to the processes described with regard to FIGS. 5B and 5C, respectively, while intermittently activating and deactivating the emitter or emitters 50.

FIG. 5F illustrates another arrangement in which the entirety of the wrap is subjected to the energy emitter to melt all, or substantially all, of the melt layer around all or substantially of the width and circumference of the bale 42.

FIG. 5G illustrates another arrangement where one or more emitters 50 may create dashes or discontinuities along at least part, along substantially the entire, or the entire circumference and width of the bale 42. As illustrated, the emitter(s) 50 create “spot welds” along the entirety of the circumference and width of bale 42.

Any of the joint 58 patterns of FIGS. 5A-5E, or any other joint 58 pattern suitable for retaining a given crop in a bale 42 shape, may be produced by one or more emitters 50, and the emitters 50 may be moveable relative to the rolling machine 38, the bale 42 may be rolled relative to the emitter 50, or both the bale 42 and the emitters 50 may move in concert. Any dashes or discontinuities in a joint or joints 58 may be produced by a single emitter 50 activated intermittently during such relative motion between the emitter 50 and bale 42, or multiple differently located emitters 50 activated constantly or intermittently. Further, other patterns similar to different to these illustrated examples, whether consistent or random, are also envisioned. For instance, the pattern in FIG. 5C could instead include rings of various thickness from one another (e.g., similar to a barcode look), or be off-parallel, as desired.

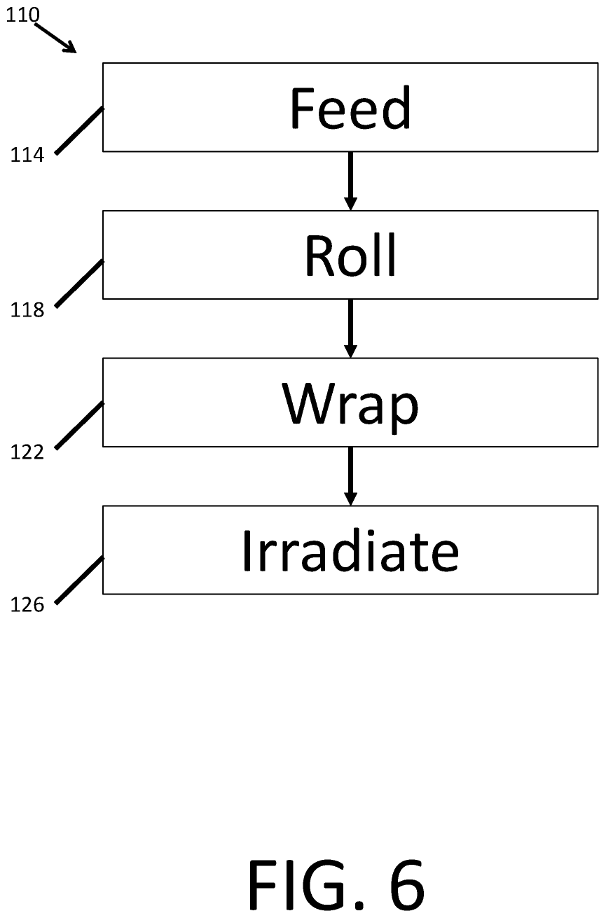

One embodiment of a method 110 of using the above described system 34 is illustrated in FIG. 6. The method 110 begins with a feeding step 114, which as is generally known in the art, includes feeding a full bale 42 or loose crop to the rolling machine 38. In a rolling step 118, as is commonly known in the art, the rolling machine 38 rolls the crop or organize and collect it into a bale 42. In a wrapping step 122, as is commonly known in the art, the wrap 10 is applied around the bale 42, typically while the bale 42 continues to be rotated. The wrap 10 is sealed as described above with regard to FIGS. 3-5E in an irradiating step 126, wherein one or more emitters 50 are activated to melt one or more portions of the melt layer 18 of the wrap 10. In various arrangements, either or both of the rolling step 118 and the wrapping step 122 continue through at least part of the irradiating step 126.

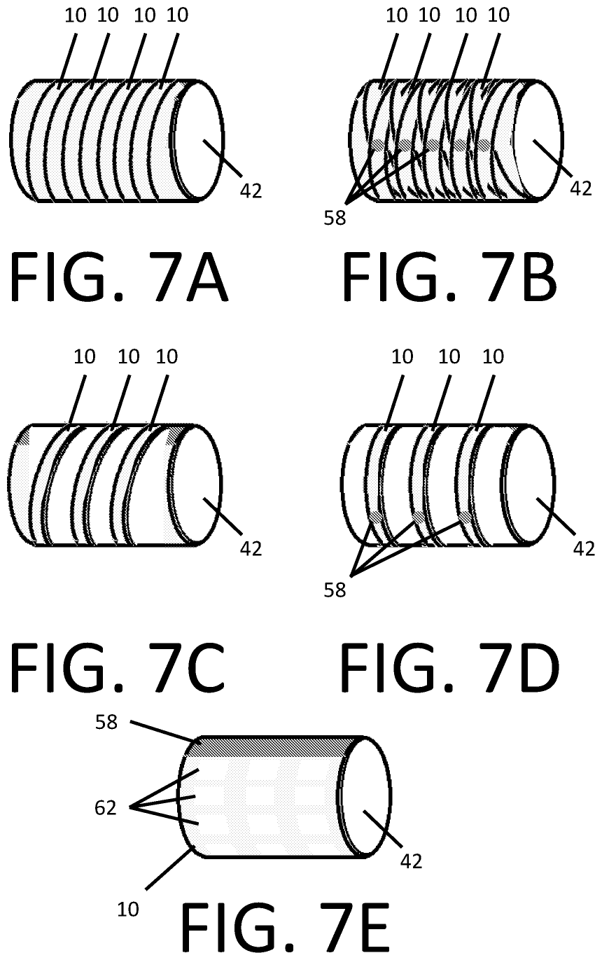

FIGS. 7A-7C illustrate exemplary arrangements for wrapping a bale 42 with one or more thin strips of bale wrap 10. In the arrangement of FIG. 7A, the wrap 10 is a thin ribbon-like shape which has a width less than the overall width of the baled item, and as illustrated, the width of wrap 10 in this example is much small than the width of the baled item overall. As illustrated in FIG. 7A, wrap 10 is wrapped around the bale 42 in an overlapping spiral or helical pattern. At least part of the overlapping portions of the wrap 10 may be irradiated to bind the wrap 10 around the bale 42.

In the arrangement illustrated in FIG. 7B, the bale wrap 10 is once again of a width less than the width of the baled item (and as illustrated, much smaller than the width of the baled item) and is wrapped in an overlapping crossing pattern around the bale 42. The wrap 10 may be irradiated to produce spot weld joints 58 at overlapping portions of the cross pattern.

As illustrated in FIG. 7C, the wrap 10 may be wrapped in a non-overlapping helical or spiral pattern around the bale 42. The arrangement of FIG. 7C may be appropriate for crops or materials able to hold a bale shape with minimal binding. The wrap 10 can be wrapped in complete rings at both ends of the bale 42 and spot welded to secure the helix of wrap 10 in place around the bale 42.

In still another arrangement, wrap 10 may constitute multiple wrapping portions which are each individually wrapped around the baled item to form parallel rings around the baled item 42 as shown in FIG. 7D. Each ring of wrapping material 10 (which may or may not overlap with adjacent rings) may be welded to itself where the ends of the particular ring overlap one another.

In yet another arrangement, the wrap 10 may include one or more holes, vents, openings, mesh or porous portions, or the like 62 along its length to allow for improved airflow through the baled item as shown in FIG. 7E. This may be beneficial for certain items which benefit from airflow to prevent the buildup of mold, for example.

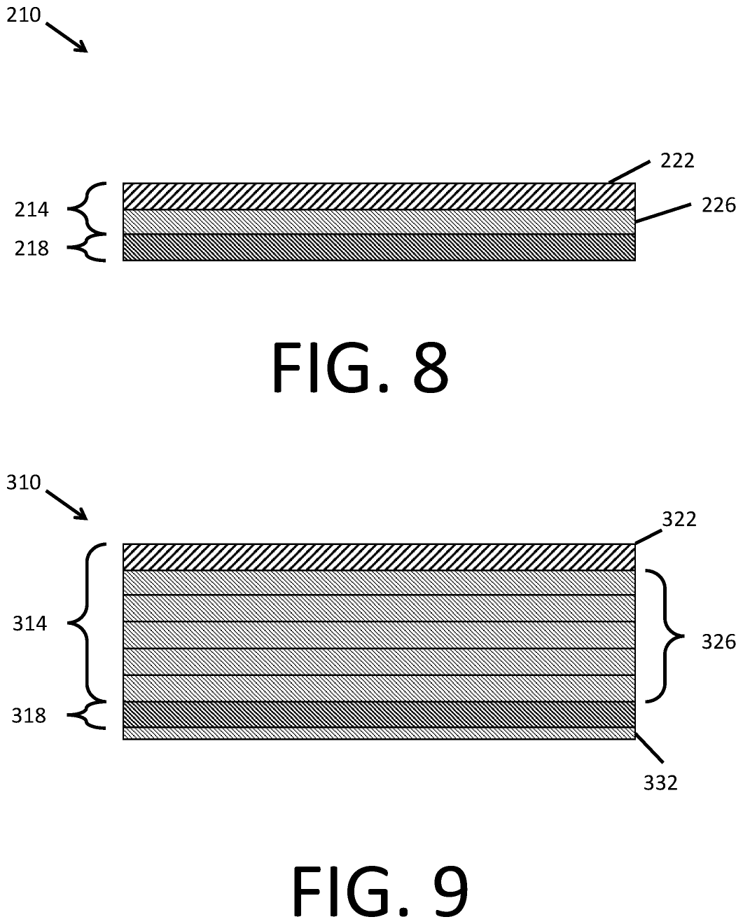

FIG. 8 illustrates a section of a bale wrap 210 according to an alternative arrangement. The wrap 210 includes a solid layer 214 and a melt layer 218, generally similar to those of the bale wrap 10 or any alternative configurations thereof described above, except that the solid layer 214 includes only one outermost sublayer 222 and one, relatively thin middle sublayer 226. The relative thinness of the solid layer 214 may facilitate feeding of the wrap 210 into a wrapping or joining machine.

FIG. 9 illustrates a section of a bale wrap 310 according to another alternative arrangement. The wrap 310 includes a solid layer 314 and a melt layer 318, generally similar to those of the bale wrap 10 or any alternative arrangements thereof described above. Moreover, the outermost sublayer 322 and the middle sublayers 326 are generally alike to those of the bale wrap 10 or any arrangements thereof described above. The bale wrap 310 also includes a relatively thin cover layer 332 covering an opposite side of the melt layer 318 from the solid layer 314.

The cover layer 332 covers the melt layer 318 and thereby reduces the friction of the wrap 310 on the melt layer 318 side of the wrap 310. The cover layer 332 may be made from any of the compositions described above with regard to the outermost layer 22 or middle sublayers 26 of the solid layer 14. However, the material of the cover layer 332 is selected to have a lower friction coefficient than the material of the melt layer 318 in at least some circumstances. In some examples, the cover layer 332 is a material that has a lower surface friction coefficient than the material of the melt layer 318 when the cover layer 332 and the melt layer 318 are completely solid. In other examples, the cover layer 332 is a material with a higher melting temperature than the material of the melt layer 318, or the cover layer 332 contains less or none of the EM absorbent additive of the melt layer 318, or both. In such examples, the cover layer 332 will thus remain completely solid and smooth even when the wrap 10 is stored in conditions that may cause the melt layer 318 to become somewhat tacky. For example, if the wrap 310 is stored in an area with high ambient temperature, or in sunlight, the melt layer 318 may heat and become tacky, or at least enter a state with a relatively high coefficient of friction, while the cover layer 332 remains completely solid.

The cover layer 332 thus maintains a low coefficient of friction on the melt layer 318 side of the wrap 310 in conditions where the melt layer 318 may be unintentionally heated. However, the cover layer 332 is provided in a material and a relatively low thickness such that the cover layer 332 will melt when the wrap 310 is intentionally subjected to the irradiation step 126 described above. The irradiated portions of the melt layer 318 will reach a high enough temperature during the irradiating step 126 to melt adjacent portions of the cover layer 332 such that the bale wrap 310 will weld onto itself generally as described above with regard to other arrangements.

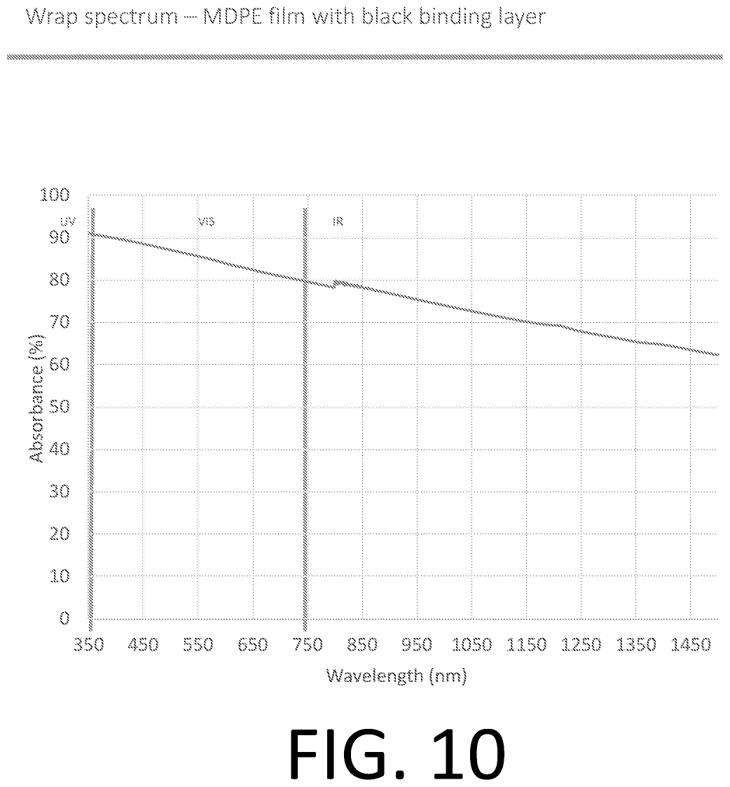

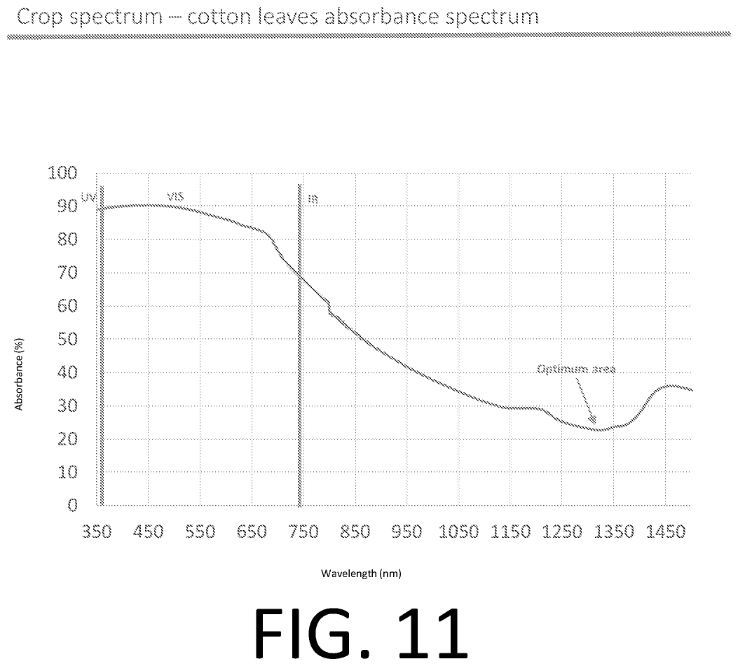

FIG. 10 illustrates the electromagnetic absorbance of an example wrap composition at various wavelengths and FIG. 11 illustrates the electromagnetic absorbance of a cotton at various wavelengths. Together, FIGS. 10 and 11 represent an exemplary process for selecting a composition for a melt layer 18, 218, 318 and an EM wavelength for use during an irradiation step 126. A material and EM absorbent additive for the melt layer 18, 218, 318 may be selected that have a significant contrast in EM absorbance to the cotton, or other selected crop, within at least one range of EM wavelengths. An EM wavelength within that range may then be selected to weld the melt layer 18, 218, 318. The contrast in EM absorbance between the melt layer 18, 218, 318 and the crop at the selected wavelength enables reliable welding with relatively little risk of heating or otherwise damaging the crop. Selecting the wavelength with the greatest contrast may therefore protect the crop, though other considerations may lead to the selection of other wavelengths.

Various tests were performed with different wraps configurations, crops, and EM sources, wavelengths, and intensities. For example, some such tests were performed with a VIS (450 nm wavelength) laser, which is one example of a usable wavelength. Other such tests were performed with a laser diode array outputting a laser at 1470 nm wavelength upon a 23 mm² spot on two layers of a test wrap overlying various crops for an exposure time of 1 minute, with the diode being powered at a different intensity per trial. The table below sets out the results observed with the 1470 nm wavelength laser exemplary tests:

| Diode | Energy | Result | Result | Result | Result |
|---|---|---|---|---|---|
| Power | Density | on Film | on Leaf | on Seed | on Cotton |
| 1.2 W | 52 mW/mm² | Welding | No change | | No change |
| | | Threshold | | | |
| 3.6 W | 156 mW/mm² | Welding | | No change | No change |
| 5.2 W | 226 mW/mm² | Welding | | No change | No change |
| 6 W | 261 mW/mm² | Welding | Heating | | No change |
| | | | Threshold | | |
| 8.5 W | 370 mW/mm² | Welding | Heating | | Heating |
| | | | Threshold | | threshold |

Thus, for the wrap tested above, it can be concluded that a laser wavelength of 1470 nm may be used at an energy density of 50-226 mW/mm², or even up to, or slightly exceeding 250 mW/mm², to effectively weld the wrap to itself with no risk to cotton, leaves, or seeds. Similar testing and observation may be performed with other combinations of wrap composition, laser parameters, and crops to determine safe and effective combinations thereof. Other energy sources such as hot air guns and ultrasonic welders may be tested in the same way.

In another aspect, a bale wrap may be perforated for breathability generally as described in U.S. Provisional Application No. 63/079,569, filed on Sep. 17, 2020, the disclosure of which is hereby incorporated herein by reference. The perforation may be, for example, in the form of holes with a diameter of 60 microns or less in a density of 150 or more holes per square centimeter. The holes may, more specifically, have a diameter of 50 microns or less. The holes may have roughened or raised edges on the intended outward-facing surface of the wrap. Such holes may be provided, for example, by use of a spiked wheel across which the bale wrap may be wrapped or rolled. Before, during, or after perforation of the wrap, a hydrophobic coating (the term “hydrophobic” including “superhydrophobic” as used in this paragraph) may be applied to the intended outward-facing surface of the wrap, such as by binding hydrophobic particles to the wrap. Examples of suitable hydrophobic particles include particles of silica, which may be chemically modified silica, hydrophobic titanium oxides, hydrophobic zinc oxides, a nano-clay, carbon nano-tubes, nano-fibers, or zeolites) or any combination thereof. Such perforations and/or coating may be applied across the entirety of the bale wrap, across substantially the entirety of the bale wrap, or across at least a portion of the width and/or length of the bale wrap. Any of the ideas in this paragraph may be applied separately from or in combination with any of the other concepts described herein. For example, any of the wraps 10, 210, 310, or any alternative arrangements thereof described above may be perforated and/or provided with a hydrophobic coating as described in this paragraph, provided that the selected hydrophobic coating does not substantially interfere with the selected combination of radiation wavelength for welding, pigment, and material composition. As a further example, such a coating may coat substantially the entirety of the bale wrap except along the tail portion where the welding would occur.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A bale wrap, comprising a melt layer including an additive absorbent to at least some electromagnetic radiation within a selected spectrum and a solid layer substantially free of the additive.

2. The wrap of claim 1, configured to wrap a bale such that at least a portion of the melt layer faces the bale and/or at least a portion of the melt layer faces away from the bale.

3. The wrap of claim 2, wherein a first portion of the wrap includes a melt layer as a top layer of the wrap and a second portion of the wrap includes a melt layer as a bottom layer of the wrap, wherein, in a configuration where the wrap wraps the bale, the melt layers of the first and second portions of the wrap are adapted to contact one another.

4. The wrap of claim 1, wherein the additive is carbon black.

5. The wrap of claim 1, wherein the solid layer includes a pigment reflective of at least some of a visible spectrum.

6. The wrap of claim 5, wherein the pigment is green.

7. The wrap of claim 1, wherein the selected spectrum is infrared.

8. The wrap of claim 1, wherein the selected spectrum is ultraviolet.

9. The wrap of claim 1, wherein the solid layer includes a plurality of sublayers.

10. The wrap of claim 9, wherein at least one of the sublayers includes a pigment reflective of at least some of a visible spectrum.

11. The wrap of claim 10, wherein a sublayer furthest from the melt layer is a transparent sublayer.

12. The wrap of claim 11, wherein the sublayers other than the transparent sublayer are collectively opaque to the visible spectrum.

13. The wrap of claim 1, wherein the solid layer is transparent to the selected spectrum, and the melt layer is opaque to the selected spectrum.

14. The system of claim 1, wherein the solid layer is composed of one or both of polyethylene and a pigment and the melt layer is composed of any one of or any combination of ethylene butyl acrylate, vinyl acetate, and ethylene vinyl acetate copolymer resin in addition to the additive.

15. A method of sealing a bale, the method comprising:
wrapping the bale by rolling the bale while applying a wrap to the bale, the wrap including a melt layer including an additive and a solid layer substantially free of the additive;
melting at least part of the melt layer by directing electromagnetic radiation at the wrap, the electromagnetic radiation being within a spectrum absorbable by the additive.

16. The method of claim 15, wherein the melting step is performed during the wrapping step.

17. The method of claim 16, wherein the melting step begins after the wrap is applied to an entire circumference of the bale such that the electromagnetic radiation does not reach the baled item, except to any extent that it bypasses the additive.

18. The method of claim 16, wherein the melting step includes driving an emitter to direct the electromagnetic radiation at differing points across a width of the wrap.

19. The method of claim 15, wherein the melting step is performed after the wrapping step is complete.

20. The method of claim 19, wherein the melting step is performed by emitting the electromagnetic radiation from an emitter, and wherein the emitter and the bale are immobile relative to one another throughout the melting step.
